(19) United States
(12) Patent Application Publication
(10) Pub. No.: US 2010/0070857 A1
(43) Pub. Date: Mar. 18, 2010

(54) METHOD AND APPARATUS FOR EDITING AN IMAGE

(75) Inventor: Handoko Kohar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/531,161

(22) PCT Filed: Mar. 12, 2008
(86) PCT No.: PCT/IB08/50885

§ 371 Date: Sep. 14, 2009

(30) Foreign Application Priority Data
Mar. 15, 2007 (EP) 07104231.1

(51) Int. Cl. G06F 3/00; G09G 5/00

(52) U.S. Cl. 715/705; 345/649

(57) ABSTRACT

An image 100 is edited in accordance with an operation. A guide 103 for guiding a user to select an operational value for the operation by dragging a position 101 in the image 100 is displayed. Furthermore, a plurality of operational values associated with corresponding positions on the guide 103 is displayed. The operation is then performed on the image 100 width selected operational value.

### FIELD OF THE INVENTION

The present invention relates to a method and apparatus for editing an image. In particular, it relates to editing a digital image as it is displayed.

### BACKGROUND OF THE INVENTION

Many systems exist for enabling a user to edit a digital image captured by a device which is subsequently downloaded and/or stored on a processing system such as a PC, networked processor, Internet provider etc. Examples of such editing systems are Photo album print software, such as Dixons, Hema, DTP applications such as Quark Express.

In a photo album editor, or any DTP editor with image frames arranged in a layout, it is often desirable to carry out a number of operations on the captured image such as move the frame, pan the image, resize the frame, zoom the image, rotate the frame etc.

Existing editors operate on the basis of direct manipulation such as a mouse or touch screen to bring about the desired editing effect. This type of editors force the user to work in separate modes: the first mode to select one of the operations, and a second mode to drag a handle to bring about the desired effect. However, these existing editors are not intuitive.

### SUMMARY OF THE INVENTION

The invention seeks to provide a technique for enabling easier and move intuitive editing of an image.

This is achieved, according to a first aspect of the present invention, by a method for editing an image in accordance with an operation, the method comprising the steps of displaying a guide for guiding a user to select an operational value for an operation on an image by dragging a position in the image,

displaying a plurality of operational values associated with corresponding positions on the guide, and performing the operation on the image with the selected operational value. The position in the image may be a pixel or group of pixels of the image or an icon superimposed on the image, for example.

This is also achieved, according to a second aspect of the present invention, by an apparatus for editing an image in accordance with an operation, the apparatus comprising electronic circuitry operative to display a guide for guiding a user to select an operational value for an operation on an image by dragging a position in the image, display a plurality of operational values associated with corresponding positions on the guide, and perform the operation on the image with the selected operational value.

The guide provides an easier and more intuitive means for the user to edit the image. More particularly, the guide provides the user with indication of how far to drag to bring about the desired editing effect and a visual indication of the effect of the edit operation i.e. a sense of scale. Furthermore, the guide is displayed such that the user can edit the images with a reduced chance that the drag moves out of the screen. The editing operations may include resizing, rotation and/or cropping of an image. The guide may be linear with operational values positioned to scale along the guide. Selection may be made by selecting an on-screen icon and dragging the selected icon along the guide to the required value. The icon and guide are displayed with the image giving the user a clear indication of the scale of each value to set a value for the operation.

### BRIEF DESCRIPTION OF DRAWINGS

For a more complete understanding of the present invention, reference is made to the following description taken in conjunction with the accompanying drawings, in which:

FIG. 1 is an illustration of an embodiment of the present invention; and

FIG. 2 is an illustration of another embodiment of the present invention.

### DETAILED DESCRIPTION OF AN EMBODIMENT OF THE INVENTION

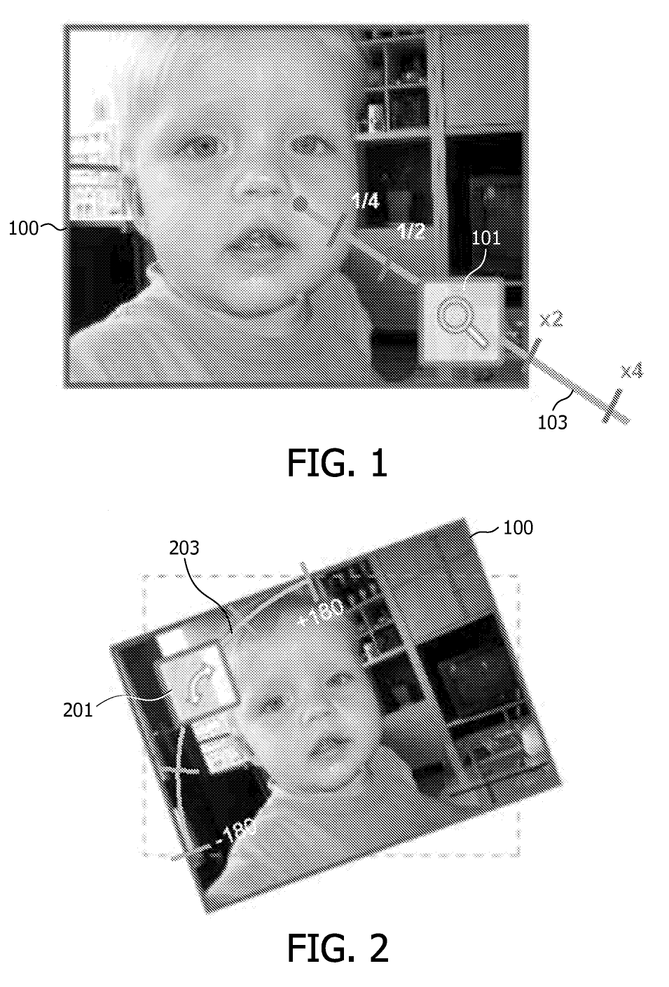

FIG. 1 illustrates an image 100. In editing mode, the image 100 is displayed with a plurality of operational icons (not shown). Once such an icon is selected, e.g. upon moving a mouse pointer over or touching a touch-sensitive screen or the like on the operational icon, the guide 103 is superimposed over the image 100.

The guide 103 is linear and extends from the centre of the image 100. The guide 103 comprises a plurality of operational values which are displayed, to scale, along the length of the guide 103. In the specific example, a resizing operational icon 101 is illustrated with scale values x ¼, x ½, x2 and x4 displayed along the guide 103. The operational values are located on the guide 103 to correspond the actual size of the resulting image if the value is selected.

The user can then simply drag the operational icon 101, representing a position in the image, along the guide to the value required. As the icon 101 is moved, the image may be dynamically scaled. Release of the operational icon 101 finalizes the size of the image 100 to the value upon which the operational icon 101 rests.

In FIG. 2, the image 100, which is displayed, is to be rotated by activation of the rotation operational icon 201. This causes a curved guide 203 to be displayed. The guide 203 comprises a plurality of operational values which are displayed around the curve of the guide 203 to indicate the actual angle of rotation. As a result the image 100 is rotated in a clockwise or anticlockwise direction by the number of degree selected on the guide 203.

The apparatus of the invention may be an electronic photo frame or a PC, for example. The electronic circuitry may be a general purpose processor or an application specific processor, e.g. an IC. The apparatus preferable has a touch screen. The apparatus may store images and/or may be operative to retrieve images from an external apparatus, e.g. using the Internet.

Although an embodiment of the present invention has been illustrated in the accompanying drawing and described in the foregoing detailed description, it will be understood that the invention is not limited to the embodiment disclosed, but is capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for editing an image in accordance with an operation, the method comprising the steps of:
displaying a guide for guiding a user to select an operational value for an operation on an image by dragging a position in the image;
displaying a plurality of operational values associated with corresponding positions on the guide; and
performing the operation on the image with the selected operational value.

2. A method according to claim 1, wherein the position in the image is represented by an icon.

3. A method according to claim 1, wherein the operation is one of resizing, rotation and cropping of said image.

4. A method according to claim 1, wherein the user is only allowed to drag the position along the guide.

5. A computer program product comprising a plurality of program code portions for carrying out the method according to claim 1.

6. Apparatus for editing an image in accordance with an operation, the apparatus comprising electronic circuitry operative to:
display a guide for guiding a user to select an operational value for an operation on an image by dragging a position in the image;
display a plurality of operational values associated with corresponding positions on the guide; and
perform the operation on the image with the selected operational value.
